(19) United States
(12) Patent Application Publication
(10) Pub. No.: US 2026/0123807 A1
(43) Pub. Date: May 7, 2026

(54) DAUGHTER BOARD FOR VACUUM CLEANER

(71) Applicant: MILWAUKEE ELECTRIC TOOL CORPORATION, Brookfield, WI (US)

(72) Inventors: Zichen Tan, Oak Creek, WI (US); Jonathan S. Pinske, Pewaukee, WI (US)

(21) Appl. No.: 19/378,947

(22) Filed: Nov. 4, 2025

Related U.S. Application Data
(60) Provisional application No. 63/716,537, filed on Nov. 5, 2024.

(51) Int. Cl. A47L 9/28; H05F 3/02

(52) U.S. Cl. CPC A47L 9/2889; A47L 9/2884; H05F 3/02

(57) ABSTRACT

One embodiment provide an air movement device including a housing, a motor within the housing and generating an airflow, a sensor terminal to detect water during operation of the motor, a circuit board including a controller coupled to the sensor terminal, and an electrostatic discharge protection circuit electrically connected between the sensor terminal and the controller. The electrostatic discharge protection circuit limits electrostatic discharge current between the sensor terminal and the controller.

### RELATED APPLICATIONS

This application claims priority to U.S. Provisional Patent Application No. 63/716,537, filed November 5, 2024, the entire contents of which are incorporated herein by reference.

### FIELD

The present disclosure relates to daughter board having an electrostatic discharge circuit for a vacuum cleaner.

### SUMMARY

In some aspects, the techniques described herein relate to a power tool including a sensor terminal and an electrostatic discharge protection circuit connected to the sensor terminal and configured to limit electrostatic discharge current.

In some aspects, the techniques described herein relate to a power tool including a first circuit board configured to interface with a power source, the power source having a negative or ground connection, a second circuit board including a sensor terminal, and an electrostatic discharge (ESD) protection circuit electrically connected to the sensor terminal, the ESD protection circuit configured to provide a current path to the negative or ground connection.

In some aspects, the techniques described herein relate to an air movement device including a housing, a motor within the housing and configured to generate an airflow, and a sensor terminal configured to detect water during operation of the motor, a circuit board including a controller communicatively coupled to the sensor terminal, and an ESD protection circuit electrically connected between the sensor terminal and the electronic processor, the ESD protection circuit configured to limit electrostatic discharge current between the sensor terminal and the controller.

In some examples, the techniques described herein relate to a power tool including a sensor terminal and an electrostatic discharge limiting circuit connected to the sensor terminal and configured to limit electrostatic discharge current.

In some examples, the electrostatic discharge limiting circuit is configured to route an excess current to a ground connection. In some examples, the power tool further includes an electronic processor electrically connected to the sensor terminal via the electrostatic discharge limiting circuit. In some examples the electrostatic discharge limiting circuit is provided on a circuit board. In examples, the power tool further includes a housing, a hose connected to the housing, and a motor configured to generate an airflow through the hose and provide a suction force to draw debris and fluid into the housing.

In some examples, the power tool includes a battery pack, wherein the ground connection is a negative battery reference. In some examples, the power tool further includes an AC power source, wherein the ground connection is a protective earth ground connection.

In some examples, the power tool further includes a battery pack including a negative battery reference, and an AC power source including a protective earth ground connection. In some examples, the electrostatic discharge limiting circuit includes a first current path configured to route the excess current to the negative battery reference and a second current path configured to route the excess current from the sensor to the protective earth ground connection.

In some examples, the electrostatic discharge limiting circuit includes a first capacitor and a first resistor configured to limit the excess current along the first current path and a second capacitor and a second resistor configured to limit the excess current along the second current path. In some examples, the first capacitor and the first resistor are configured to absorb a transient current event of the excess current as the excess current is routed along the first current path. In some examples, the second capacitor and the second resistor are configured to absorb a transient current event of the excess current as the excess current is routed along the second current path.

### BRIEF DESCRIPTION OF DRAWINGS

FIGS. 1A and 1B are perspective views of a power tool, according to some aspects.

FIG. 2 is a functional block diagram of an arrangement of circuit boards in a power tool, according to some aspects.

FIG. 3 is a block diagram of a controller, a power source, and a motor of a power tool, according to some aspects.

FIG. 4 is a circuit diagram of a circuit board of FIG. 2, according to some aspects.

FIG. 5 is a plan view of the circuit board of FIG. 4, according to some aspects.

### DETAILED DESCRIPTION

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Wet-dry vacuums are cleaning tools designed to handle both fluid spills and dry debris. These devices use a motor to create a suction force, drawing materials through a hose into a collection tank. The incoming air passes through a filter system, which traps particles and debris before the air is expelled through an exhaust port. During operation, especially when vacuuming dry materials, electrostatic charge can accumulate within the vacuum's hose or housing. This buildup occurs due to friction between particles and surfaces (e.g., the interior of the hose or housing), the separation of charged particles in the airflow, and/or low humidity conditions.

The accumulation of electrostatic charge can lead to electrostatic discharge (ESD) events, which can create sparks, potentially igniting flammable materials or gases in the environment, or may damage sensitive electronic components within the vacuum, leading to component failure. In some examples, the discharge of the accumulated energy is described as a transient current or an excess current. Components along the current path as the excess current is discharged may be damaged or destroyed unless protective/preventative measures are taken. Transient current from repeated ESD events can lead to component failure, further reducing the overall efficiency of the vacuum device. Accordingly, systems and methods to prevent ESD events are beneficial for the efficient operation of wet-dry vacuums. By mitigating or eliminating ESD events, manufacturers can create more reliable wet-dry vacuum system.

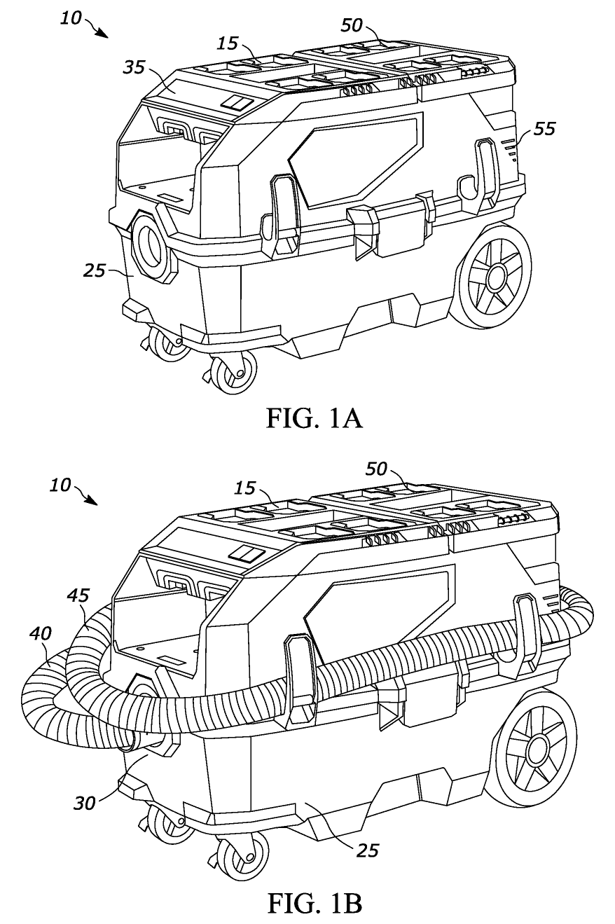

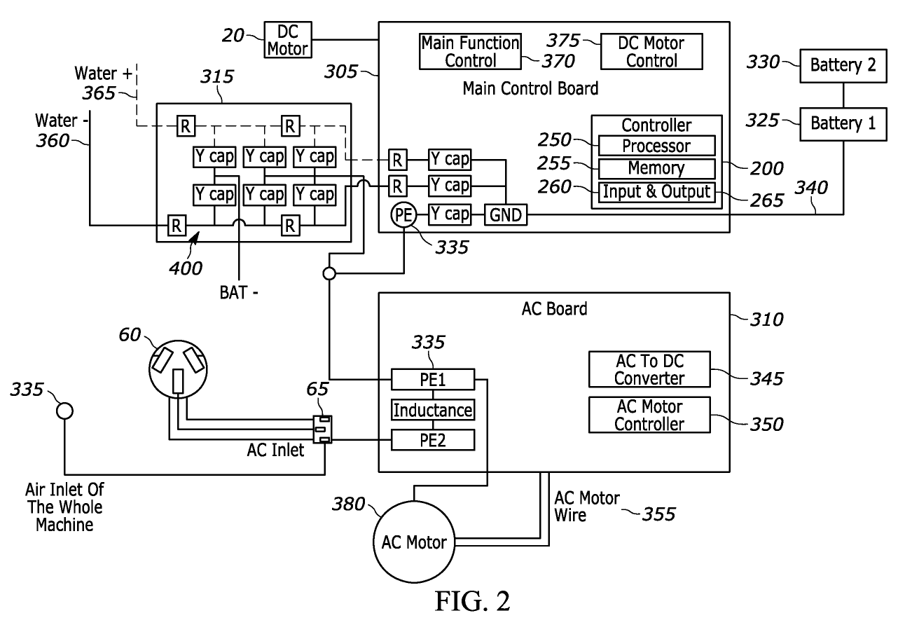

FIGS. 1A and 1B illustrate a power tool in accordance with some embodiments. As an example, the power tool is a powered wet/dry vacuum 10 (also referred to as a vacuum or a shop-vac) that includes a housing 15, a tank 25 (also referred to as a canister), and a filter 30 within the housing 15. A power switch 35 is positioned on the outside surface of the housing 15 and is configured to turn the vacuum 10 ON and/or OFF. The vacuum 10 also includes a hose 40 having a nozzle 45 that may be configured to connect with nozzle accessories (not shown). In some examples, nozzle accessories are stored in a storage slot 50 within the housing 15. The housing 15 includes an exhaust port 55 configured to allow air drawn in through the hose 40 to exit the housing 15. In some examples, the exhaust port 55 is configured as a drain port that allows excess fluid within the tank 25 to drain out of the vacuum 10. In other examples, the drain port is separated from the exhaust port 55. The housing 15 may also include air flow conduits (not illustrated) configured to direct airflow generated by a motor of the vacuum (See FIG. 2) to draw in air into the hose 40 and through the filter 30. When the vacuum 10 is in operation, the motor generates a suction force of air to pick up debris and fluid at the nozzle 25. The debris and fluid are then drawn through the hose 40 and into the filter 30, which captures some of the debris. The air flow conduits then direct the air into the tank 25, which captures the fluid and remaining debris. Excess air is then channeled by the air flow conduits out of the exhaust port 55.

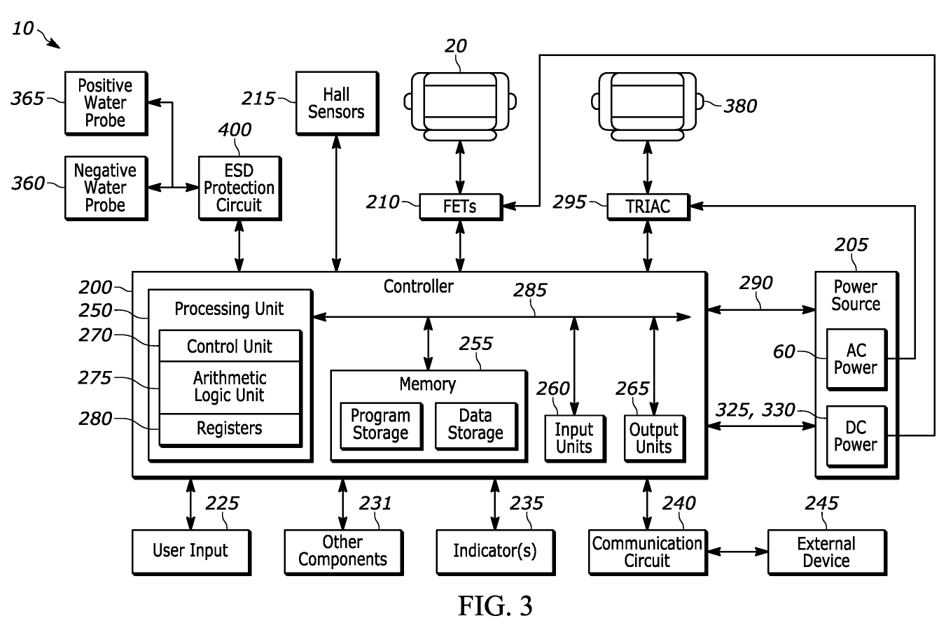

The vacuum 10 may be powered by both AC and DC power sources. For example, the vacuum 10 includes an AC power input 65 configured to receive power from an AC power source 60 (see FIG. 3) (for example, a wall outlet). The vacuum 10 may also include one or more battery pack interfaces to receive, for example, power tool battery packs 325, 330 (See FIG. 3). In one example, the power tool battery pack may be an 18-volt (e.g., nominal voltage) power tool battery pack. Alternatively, the battery pack may have a different nominal voltage (e.g., 12 volts, 18 volts, 36 Volts, etc.). Additionally, or alternatively, the battery cells may include chemistries, for example, lithium-ion, nickel cadmium, nickel metal-hydride, or the like. In some examples, the vacuum 10 includes multiple motors such as a first motor configured to operate using the DC power source from the battery packs 325, 330 and a second motor configured to operate using the AC power source 60.

Although the illustrated embodiment of FIGS. 1A and 1B is vacuum 10, it should be understood that the features of the invention described herein may relate to other power tool applications or air movement device applications. For example, the features described may be applicable to any power tool system that operates on AC and DC power sources and is susceptible to electrostatic charge accumulation. Such electrostatic charge buildup may be common in tools that generate a high-velocity airflow to move dry materials (e.g., dust, debris, or particles) through a hose or conduit. In some instances, the power tool and/or air movement device may be a dust extractor, wet/dry vacuum, mulching vacuum, blower, shop-vac, fan, a leaf blower, an air conditioner, a leaf collector, or the like. The air movement device may include suction and/or blowing capabilities and may use one or more motors for each capability.

FIG. 2 is functional block diagram of the vacuum 10, according to some aspects. In the example illustrated, the vacuum 10 includes a main control board 305, an AC board 310, a daughter board 315, an AC motor 380, and a DC motor 20. The main control board 305 includes a main function control 370 and a DC motor control circuit 375. The main function control 370 controls the communication between the main control board 305, the AC board 310, and the daughter board 315, along with other operations of the vacuum 10. In some examples, the main function control 370 may be performed by the controller 200. In other examples, the main function control 370 may be performed by an alternative controller. The DC motor control circuit 375 controls (e.g., drives) the DC motor 20 using, for example, an inverter bridge. The daughter board 315 includes smaller dimensions and is separate from the other circuit boards 305, 310. In one example, the daughter board 315 is dedicated to an electrostatic discharge (ESD) protection circuit 400 (also referred to as an electrostatic discharge limiting circuit). In some examples, the ESD protection circuit is provided on the main control board 305 or the AC board 310 and the daughter board 315 may not be needed or may be modified accordingly. FIG. 2 illustrates only one example embodiment of the circuit board arrangement. Other examples may have a different configuration (e.g., the components may be provided on a single circuit board or distributed across any number of circuit boards).

The main control board 305 is also configured to interface with a power source, such as a first battery pack 325 and a second battery pack 330 via a terminal connector (that is, a battery pack interface). In some embodiments, the vacuum 10 includes multiple terminal connectors that connect to multiple battery packs simultaneously and/or different battery pack connector profiles. For example, the vacuum 10 may include a first terminal connector for connecting to the first battery pack 325 and a second terminal connector for connecting to the second battery pack 330. When multiple battery packs 325, 330 are connected, the main function control 370 may selectively control power drawn from either the first battery pack 325 or the second battery pack 330, or a combination of the battery packs. The main control board 305 also includes a ground 335 connection, sometimes referred to as protective earth (PE) ground, which connects to the ground plane (not illustrated) of the main control board 305 to a ground reference shared by the main control board 305, the AC board 310, and the daughter board 315. In some examples, the vacuum 10 may include only two circuit boards including the daughter board 315 and one other circuit board. For example, the vacuum 10 may include only a DC motor 20 and only a DC power source, such as the battery pack 325, 330. In this example, the AC board 310 may not be included in the vacuum 10. Alternatively, in some embodiments, the vacuum 10 may only include an AC motor 380 powered by the AC power source 60. In this example, the main control board 305 may not be included in the vacuum 10, and the AC board 310 may include additional elements such as the main function control 370 and/or the controller 200. In yet other embodiments, the components of the main control board 305 and the AC board 310 may be combined into a single circuit board.

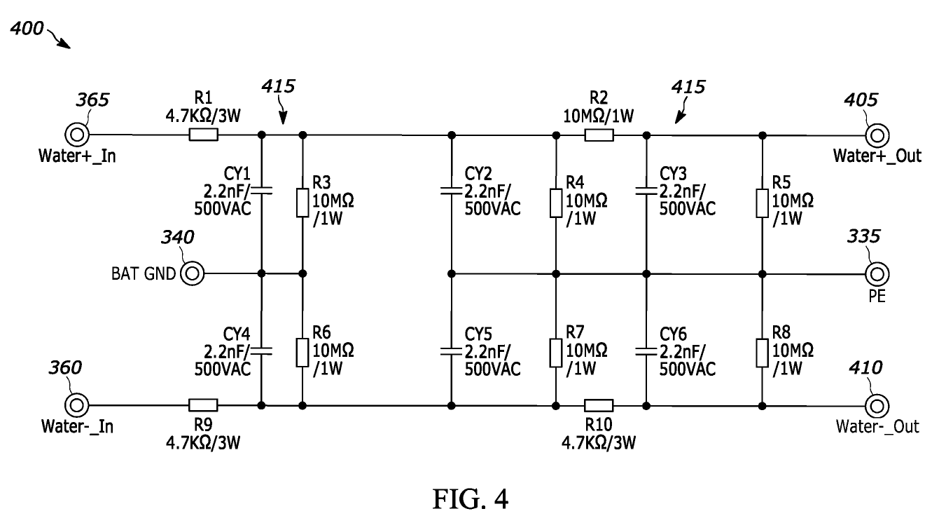

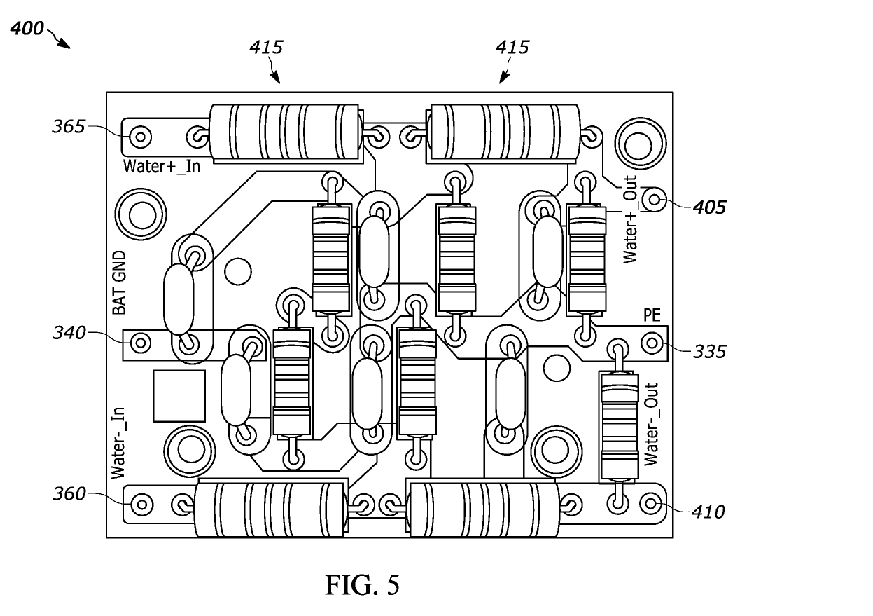

The AC board 310 includes an AC to DC converter 345 configured to convert AC power from the AC power source 60 into a DC signal. The AC board 310 also includes an AC motor control circuit 350 configured to control the AC motor 380 and provide operating power via motor wires 355 to the motor. Like the main control board 305, the AC board 310 includes a ground 335 connection for connecting the AC board 310 to a common ground. The daughter board 315 electronically connects to both the main control board 305 and the AC board 310 via the ground 335 connection shared by both boards 305, 310. When a first battery pack 325 or a second battery pack 330 is connected, the daughter board 315 also electronically connects with the negative battery reference 340 of the battery pack. The ESD protection circuit 400 of the daughter board 315 electrically interfaces with two water sensing probes, a negative water probe 360 and a positive water probe 365 (also referred to as water sensors or sensor terminal(s)). The water sensing probes 360, 365, when included, are exposed and configured to detect the presence of water when the vacuum is in use (e.g., during operation of the motor). In response to the presence of water being detected, the ESD protection circuit 400 routes a detection signal generated by the water sensing probes 360, 365 to the main control board 305. The ESD protection circuit 400 is illustrated in greater detail in FIG. 4 and FIG. 5 and described below.

In some embodiments, the vacuum 10 may include a single motor rather than an AC motor 380 and a DC motor 20 (e.g., a DC brushless motor). In these embodiments, the single motor may be controlled by the AC motor control circuit 350 and the DC motor control circuit 375 depending on which power source is powering the vacuum 10.

FIG. 3 illustrates a block diagram of the vacuum 10 which includes a controller 200 (for example, the combination of the main function control 370, the controller of the DC motor control circuit 375, and the controller of the AC motor control circuit 350). The controller 200 is electrically and/or communicatively connected to a variety of modules or components of the vacuum 10. For example, the illustrated controller 200 is connected to the power source 205 (e.g., previously described as the AC power source 60 or the DC power source in some implementations), one or more FETs 210, a TRIAC 295, the motors 20, 380, one or more Hall effect sensors 215 (also referred to as Hall sensors), a user input 225 (e.g., the power switch 35), one or more other components 231 (e.g., a battery pack fuel gauge, work lights [e.g., LEDs], current/voltage sensors, etc.), one or more indicators 235 (e.g., LEDs), and a communication circuit 240 (e.g., a transceiver or a wired interface) configured to communicate with an external device 245 (e.g., a smartphone, a tablet computer, a laptop computer, and the like). The controller 200 is also connected to the water sensing probes 360, 365 through the ESD protection circuit 400. In some examples the ESD protection circuit 400 also connects with the power source 205 or elements of the power source 205, such as the AC power 60 or the battery packs 325, 330.

In some embodiments, the user input 225 includes a switch, such as the power switch 35, for selectively providing power to the vacuum 10. The user input 225 may include additional or alternative input elements, such as a multi-position switch for providing different levels of power, a switch for selecting a source of power (e.g., an AC power source or a DC power source, or both AC and DC power sources), or a switch for selecting a motor. Indicators 235 are used to provide indications of the system, such as an ON/OFF status, a selected power source, an error condition, or the like. The communication circuit 240 may be used to receive control signals from the external device 245 via a wired or wireless connection.

The controller 200 includes combinations of hardware and software operable to, among other things, control the operation of the vacuum 10, control power provided to the motor (e.g., AC motor 380 and/or DC motor 20), etc. In some embodiments, the controller 200 (e.g., an electronic processor) includes a plurality of electrical and electronic components that provide power, operational control, and protection to the components and modules within the controller 200 and/or vacuum 10. For example, the controller 200 includes, among other things, a processing unit 250 (e.g., a microprocessor, a microcontroller, or another suitable programmable device), a memory 255, input units 260, and output units 265. The processing unit 250 includes, among other things, a control unit 270, an arithmetic logic unit (“ALU”) 275, and a plurality of registers 280 (shown as a group of registers in FIG. 2) and is implemented using a known computer architecture (e.g., a modified Harvard architecture, a von Neumann architecture, etc.). The processing unit 250, the memory 255, the input units 260, and the output units 265, as well as the various modules connected to the controller 200 are connected by one or more control and/or data buses (e.g., a common bus 285). The control and/or data buses are shown generally in FIG. 2 for illustrative purposes. The use of one or more control and/or data buses for the interconnection between and communication among the various modules and components would be known to a person skilled in the art in view of the invention described herein.

The memory 255 is a non-transitory computer readable medium that includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 250 is connected to the memory 255 and executes software instructions that are capable of being stored in a RAM of the memory 255 (e.g., during execution), a ROM of the memory 255 (e.g., on a generally permanent basis), or another non-transitory computer readable medium such as another memory or a disc. Software included in the implementation of the vacuum 10 can be stored in the memory 255 of the controller 200. The software includes, for example, firmware, one or more applications, program data, filters, rules, one or more program modules, and other executable instructions. The controller 200 is configured to retrieve from memory and execute, among other things, instructions to perform the motor and tool control described herein. In other constructions, the controller 200 includes additional, fewer, or different components.

The power source 205 provides power to the various components of the device 10. As previously described, in some examples the power source 205 may be implemented as an AC power source 60 which provides AC power (e.g., 120V/60Hz) to the AC input port 65 that is coupled to a standard wall outlet, and then filter, condition, and rectify the received power to output DC power. In other examples, the power source 205 may be implemented as a DC power source which provides a DC power, such as the battery packs 325, 330. When the vacuum 10 is configured to operate using the AC power source 60, the AC power may be provided directly to the AC motor 380 and/or to the AC motor 380 through the TRIAC 295. In some examples, the vacuum 10 includes, for example, a communication line 290 for providing a communication line or link between the controller 200 and the power source 205. Although the AC power and the DC power are described separately, it should be understood that the vacuum 10 may operate using only one power source (e.g., only AC power from the AC power source 60 or only DC power from the battery pack 325, 330) or may operate using both the AC power and DC power simultaneously. In some embodiments, a user may select which power source to operate from. In some embodiments, the selection of a power source is performed by the controller 200.

Each of the Hall sensors 215 outputs motor feedback information, such as an indication (e.g., a signal or a pulse) related to when a magnet of the rotor of the motor 20, 380 rotates across the face of that Hall sensor 215. Based on the motor feedback information from the Hall sensors 215, the controller 200 is configured to determine the rotational position, speed, and/or acceleration of the rotor. In some examples, the vacuum 10 includes two motors, an AC motor 380 and a DC motor 20. As previously described, the AC motor 380 is operated using an AC power source 60 and the DC motor 20 is operated using a DC power source, such as the battery packs 325, 330. In some embodiments, the vacuum 10 may include a combination of controllers that independently control the AC motor 380 and the DC motor 20, among other functions. For example, the DC motor control circuit 375 controls operation of the DC motor 20 and the AC motor control circuit 350 controls operation of the AC motor 380. In some embodiments, a single controller (e.g., controller 200) may perform both control of the AC motor 380 and the DC motor 20. In yet other embodiments, only one motor may be included in the vacuum 10 and only one motor controller may control the motor. In some embodiments, the controller 200 may be configured to operate the DC motor 20 using sensorless control techniques. For example, the controller 200 may be configured to determine the rotor's position and speed by measuring and analyzing the back-EMF (Back Electromotive Force) generated in the un-energized motor windings. In other such embodiments, the controller 200 may implement a sensorless field-oriented control (FOC) method using measurements of the DC motor 20 phase currents and voltages to estimate the rotor position.

FIG. 4 is a circuit diagram of the ESD protection circuit 400, according to some aspects. FIG. 5 illustrates a configuration of the ESD protection circuit 400 on a circuit board (e.g., the daughter board 315) according to the circuit diagram of FIG. 4. As previously described, the ESD protection circuit 400 electrically connects with a negative water probe 360, a positive water probe 365, a ground 335 connection, and a connection to the negative battery reference 340 of the battery pack. The ESD protection circuit 400 also includes two water-out connections, a positive water-out connection 405 and a negative water-out connection 410, which are connected to the controller 200, for example, the main function control 370 of the main control board 305. When water is detected during operation of the vacuum 10, the water sensing probes 360, 365 generate a signal that is passed through (that is, routed through) the isolation elements 415 of the ESD protection circuit 400 and is output by the water-out connections 405, 410 to the controller 200. Due to the presence of debris during the vacuuming processes, a large number of statically charged particles may also accumulate in the hose 40 or within the vacuum, causing a continuous static charge to build up and discharge into the system (e.g., an electrostatic discharge), which may cause damage to components on the main control board 305, the AC board 310, or in other electronic elements of the vacuum 10. The ESD protection circuit 400 is therefore advantageously constructed to provide a passive discharge of any charged particles of static build-up before an undesired discharge occurs.

The ESD protection circuit 400 includes resistors R1 and R9, which are used to limit the current provided to the controller 200. This current limit is provided both when the vacuum 10 is operating using the AC power source 60 or the DC power provided by a battery pack, such as the first or second battery packs 325, 330. When the vacuum 10 is operating using power provided by a battery pack, capacitors CY1 and CY4 are used to absorb any transient charges caused by the static build up, and resistors R3 and R6 function as discharge paths to dissipate accumulated electric charge across the water sensing probes 360, 365. Resistors R3 and R6 reduce uncontrolled charge accumulation that may lead to capacitor saturation of the capacitors CY1 and CY2. Such saturation may trigger an electrostatic discharge event, electrical arcing, or generate high-voltage transients capable of causing system damage to the controller 200. Accordingly, the configuration of resistors R1, R3, R6, and R9, and capacitors CY1 and CY4 together allow the ESD protection circuit 400 to ground any electric charge built up across the water sensing probes 360, 365 via the negative battery reference 340. The ESD protection circuit 400 provides a current path to route excess current to the negative battery reference 340, preventing any of the excess current from passing to more sensitive components on the main control board 305 or the AC board 310.

When an AC power cable is connected to the AC power input port 65, the ground 335 connection is connected to earth ground. When the vacuum 10 is operating using power provided by the AC power source 60, a greater amount of electrostatic build up may be generated by the motor 20, 380. To counter this increased charge accumulation, resistors R2 and R10 are used alongside resistors R1 and R9 to limit the current provided to the controller 200. Additionally, capacitors CY2, CY3, CY5, and CY6 are used to absorb any transient charges caused by the static build up and operate similarly to capacitors CY1 and CY4. Likewise, resistors R4, R5, R7, and R8 discharge and dissipate accumulated electric charge across the water sensing probes 360, 365, and function similarly to resistors R3 and R6. Accordingly, the configuration of resistors R1, R2, R4, R5, R7, R8, R9, and R10, and capacitors CY2, CY3, CY5, and CY4 together allow the ESD protection circuit 400 to ground any electric charge built up across the water sensing probes 360, 365 via the ground 335 connection. Similar to the previous described current path with respect to the negative battery reference 340, the ESD protection circuit 400 also provides another current path to route excess current to the ground 335 connection. In some examples, when both the battery pack 325, 330 and the AC power source 60 are connected, excess current may be routed to either the negative battery reference 340, the ground 335 connection, or both. In some examples, when both the battery pack 325, 330 and the AC power source 60 are connected, the excess current is routed to the ground 335 connection. The configuration shown in FIGS. 4 and 5 is only one example configuration. Other example configurations may be used to similar provide electrostatic discharge protection.

As described throughout the application, the power tool may be embodied in various forms, such as vacuum 10, depending on the desired air movement capabilities. In some embodiments, the power tool is configured as a dedicated suction device. In such a configuration, one or more motors (e.g. AC motor 380, DC motor 20, or the like) are arranged within the housing 15 to draw air and debris through an inlet (e.g., hose 40) and into a collection area (e.g., tank 25), with the air subsequently being exhausted, for example, through an exhaust port 55. In other embodiments, the power tool is configured as a dedicated blower. In this arrangement, the motor may be primarily oriented to draw in ambient air and expel exhaust air at a high velocity through a nozzle or outlet port to move debris, dust, or other materials. In some embodiments, the power tool is configured as a dual-function device capable of operating as both a suction device and a blower. In one such configuration, the airflow conduits within the housing are designed such that the exhaust airflow from the suction function (e.g., air exiting exhaust port 55) is channeled and can be used for blowing applications, for example, by attaching a hose to the exhaust port. In alternative embodiments, a dual-function tool may incorporate a first motor for generating suction and a second, separate motor for generating the blowing airflow. The specific design and routing of the airflow paths for the intake and exhaust ports may determine whether the device provides suction capability only, blower capability only, or both.

The following are examples of the present disclosure described herein. It should be understood that any of the examples may be combined to include some or all of the features of any other example. Likewise, any of the features of the illustrations as described herein may be included in any combination with any of the examples.

Example 1. A power tool comprising: a sensor terminal; and an electrostatic discharge protection circuit connected to the sensor terminal and configured to limit electrostatic discharge current.

Example 2. The power tool of example 1, wherein the electrostatic discharge protection circuit is configured to route an excess current to a ground connection.

Example 3. The power tool of any of the preceding examples, further comprising a controller electrically connected to the sensor terminal via the electrostatic discharge protection circuit.

Example 4. The power tool of any of the preceding examples, wherein the electrostatic discharge protection circuit is provided on a circuit board.

Example 5. The power tool of any of the preceding examples, further comprising: a housing; a hose connected to the housing; and a motor configured to generate an airflow through the hose and provide a suction force to draw debris and fluid into the housing.

Example 6. The power tool of example 2, further comprising a battery pack, wherein the ground connection is a negative battery reference.

Example 7. The power tool of example 2, further comprising an AC power source, wherein the ground connection is a protective earth ground connection.

Example 8. The power tool of example 2, further comprising: a battery pack including a negative battery reference, and an AC power source including a protective earth ground connection.

Example 9. The power tool of example 8, wherein the electrostatic discharge protection circuit includes a first current path configured to route the excess current to the negative battery reference and a second current path configured to route the excess current from the sensor to the protective earth ground connection.

Example 10. The power tool of example 9, wherein the electrostatic discharge protection circuit includes a first capacitor and a first resistor configured to limit the excess current along the first current path and a second capacitor and a second resistor configured to limit the excess current along the second current path.

Example 11. The power tool of example 10, wherein the first capacitor and the first resistor are configured to absorb a transient current event of the excess current as the excess current is routed along the first current path.

Example 12. The power tool of example 10, wherein the second capacitor and the second resistor are configured to absorb a transient current event of the excess current as the excess current is routed along the second current path.

Example 13. A power tool comprising: a first circuit board configured to interface with a power source, the power source having a negative or ground connection; a second circuit board including: a sensor terminal; and an electrostatic discharge (ESD) protection circuit electrically connected to the sensor terminal, the ESD protection circuit configured to provide a current path to the negative or ground connection.

Example 14. The power tool of example 13, wherein the sensor terminal includes one or more water sensing probes the one or more water sensing probes configured to output a signal to the ESD protection circuit in response to detecting water.

Example 15. The power tool of example 13, further comprising: a first capacitor and a first resistor electrically connected to the current path, the first capacitor and the first resistor configured to absorb a transient current event .

Example 16. The power tool of example 13, wherein the power source is a DC power source, the power tool further comprising: a DC motor control circuit provided on the first circuit board, the DC motor control circuit configured to drive a motor using power received power from the DC power source.

Example 17. The power tool of example 13, wherein the power source is an AC power source, the power tool further comprising: an AC motor control circuit provided on the first circuit board, the AC motor control circuit configured to drive a motor using power received power from the AC power source.

Example 18. The power tool of example 13, further comprising: a controller electrically provided on the first circuit board, wherein the third circuit board is configured to route a signal from the sensor terminal through the ESD protection circuit to the controller, the ESD protection circuit configured to prevent excess current from the sensor terminal from damaging the controller.

Example 19. An air movement device comprising: a housing; a motor within the housing and configured to generate an airflow; and a sensor terminal configured to detect water during operation of the motor; a circuit board including a controller communicatively coupled to the sensor terminal; and an ESD protection circuit electrically connected between the sensor terminal and the electronic processor, the ESD protection circuit configured to limit electrostatic discharge current between the sensor terminal and the controller.

Example 20. The air movement device of example 19, wherein the ESD protection circuit is configured to route an excess current to a ground connection .

Although the disclosure has been described in detail with reference to certain preferred embodiments, variations and modifications exist within the scope and spirit of one or more independent aspects of the disclosure as described.

What is claimed is:

1. A power tool comprising:
a sensor terminal; and
an electrostatic discharge protection circuit connected to the sensor terminal and configured to limit electrostatic discharge current.

2. The power tool of claim 1, wherein the electrostatic discharge protection circuit is configured to route an excess current to a ground connection.

3. The power tool of claim 1, further comprising a controller electrically connected to the sensor terminal via the electrostatic discharge protection circuit.

4. The power tool of claim 1, wherein the electrostatic discharge protection circuit is provided on a circuit board.

5. The power tool of claim 1, further comprising:
a housing;
a hose connected to the housing; and
a motor configured to generate an airflow through the hose and provide a suction force to draw debris and fluid into the housing.

6. The power tool of claim 2, further comprising a battery pack, wherein the ground connection is a negative battery reference.

7. The power tool of claim 2, further comprising an AC power source, wherein the ground connection is a protective earth ground connection.

8. The power tool of claim 2, further comprising:
a battery pack including a negative battery reference, and
an AC power source including a protective earth ground connection.

9. The power tool of claim 8, wherein the electrostatic discharge protection circuit includes a first current path configured to route the excess current to the negative battery reference and a second current path configured to route the excess current to the protective earth ground connection.

10. The power tool of claim 9, wherein the electrostatic discharge protection circuit includes a first capacitor and a first resistor configured to limit the excess current along the first current path and a second capacitor and a second resistor configured to limit the excess current along the second current path.

11. The power tool of claim 10, wherein the first capacitor and the first resistor are configured to absorb a transient current event of the excess current as the excess current is routed along the first current path.

12. The power tool of claim 10, wherein the second capacitor and the second resistor are configured to absorb a transient current event of the excess current as the excess current is routed along the second current path.

13. A power tool comprising:
a first circuit board configured to interface with a power source, the power source having a negative or ground connection;
a second circuit board including:
a sensor terminal; and
an electrostatic discharge (ESD) protection circuit electrically connected to the sensor terminal, the ESD protection circuit configured to provide a current path to the negative or ground connection.

14. The power tool of claim 13, wherein the sensor terminal includes one or more water sensing probes the one or more water sensing probes configured to output a signal to the ESD protection circuit in response to detecting water.

15. The power tool of claim 13, further comprising:
a first capacitor and a first resistor electrically connected to the current path, the first capacitor and the first resistor configured to absorb a transient current event.

16. The power tool of claim 13, wherein the power source is a DC power source, the power tool further comprising:
a DC motor control circuit provided on the first circuit board, the DC motor control circuit configured to drive a motor using power received power from the DC power source.

17. The power tool of claim 13, wherein the power source is an AC power source, the power tool further comprising:
an AC motor control circuit provided on the first circuit board, the AC motor control circuit configured to drive a motor using power received power from the AC power source.

18. The power tool of claim 13, further comprising:
a controller electrically provided on the first circuit board,
wherein the second circuit board is configured to route a signal from the sensor terminal through the ESD protection circuit to the controller, the ESD protection circuit configured to prevent excess current from the sensor terminal from damaging the controller.

19. An air movement device comprising:
a housing;
a motor within the housing and configured to generate an airflow; and
a sensor terminal configured to detect water during operation of the motor;
a circuit board including a controller communicatively coupled to the sensor terminal; and
an ESD protection circuit electrically connected between the sensor terminal and the controller, the ESD protection circuit configured to limit electrostatic discharge current between the sensor terminal and the controller.

20. The air movement device of claim 19, wherein the ESD protection circuit is configured to route an excess current to a ground connection.
